(19) United States
(12) Patent Application Publication
(10) Pub. No.: US 2026/0160920 A1
(43) Pub. Date: Jun. 11, 2026

(54) DISCRIMINATION METHOD AND STORAGE MEDIUM FOR SOFT ROCK DEFORMATION BASED ON HARMFUL DEFORMATION INDEX

(71) Applicants: POWERCHINA Beijing Engineering Corporation Limited, Beijing (CN); Hohai University, Nanjing (CN); POWERCHINA Kunming Engineering Corporation Limited, Kunming (CN)

(72) Inventors: Guojin Zhu, Beijing (CN); Qingxiang Meng, Nanjing (CN); Yu Ning, Kunming (CN); Tianbing Xiang, Kunming (CN); Xiaolong Yang, Kunming (CN); Chao Wang, Nanjing (CN); Qingfu Huang, Kunming (CN)

(21) Appl. No.: 19/409,877

(22) Filed: Dec. 5, 2025

(30) Foreign Application Priority Data
Dec. 7, 2024 (CN) 202411792520.0

(51) Int. Cl. G01V 20/00

(52) U.S. Cl. CPC G01V 20/00

(57) ABSTRACT

A discrimination method for soft rock deformation based on harmful deformation index is provided, which includes calculating a comprehensive strength stress ratio; determining an activity coefficient of groundwater; calculating a hydraulic coefficient of the a rock mass; determining a shape coefficient of a tunnel based on its cross-sectional shape; determining a long-term strength reduction coefficient; considering the above factors, calculating a harmful deformation index of the soft rock tunnel. Based on obtained harmful deformation index, compare it with a harmful deformation classification table of the soft rock tunnel to determine a deformation category of a surrounding rock. The present disclosure comprehensively considers physical and mechanical properties, geological conditions, hydrological environment, and time effects of the surrounding rock of the soft rock tunnel, overcoming shortcomings of traditional methods that ignore dynamic factors and environmental influences, thereby making deformation identification more comprehensive and accurate, and effectively improving risk prediction capabilities.

### CROSS-REFERENCE TO RELATED APPLICATIONS

This application claims priority to Chinese Patent Application No. 202411792520.0, filed on Dec. 7, 2024, which is hereby incorporated by reference in its entirety.

### TECHNICAL FIELD

The present disclosure relates to the field of soft rock tunnel engineering technologies, and in particular, to a discrimination method and a storage medium for soft rock deformation based on harmful deformation index.

### BACKGROUND

During the excavation process of soft rock tunnels, large deformations often occur, and corresponding support needs to be provided according to different deformation situations. Therefore, it is very important to accurately and quickly determine the type of deformation. The traditional method of judging large deformation of soft rock is mainly based on the analysis of strength stress ratio. However, a single stress intensity ratio index often cannot accurately reflect the occurrence environment and complexity of the surrounding rock, and a more accurate solution needs to be sought.

### SUMMARY

The purpose of the present disclosure is to propose a discrimination method for a soft rock deformation based on harmful deformation index, which overcomes the limitations of traditional methods, comprehensively considers physical and mechanical properties of surrounding rock, occurrence environment characteristics and other factors, accurately identifies and evaluates the stability of surrounding rock and the risk of large deformation.

To solve the above technical problems, the present disclosure adopts the following technical solution.

A discrimination method for soft rock deformation based on harmful deformation index, including the following steps:
step S1: calculating a comprehensive strength stress ratio J_{σ} based on comprehensive lithology, geostatic stress field, and rock mass structural characteristics,

$${J}_{σ} = \frac{{R}_{b} \times {R}_{cm}}{3 {k}^{2} \times {σ}_{0}^{2}}$$

in the above equation, R_{b} is a uniaxial compressive strength of a rock, R_{cm} is a uniaxial compressive strength of a rock mass, σ₀ is a value of a large principal stress of a geostatic stress and k is a ratio of the large principal stress to a small principal stress of the geostatic stress;
step S2: determining an activity coefficient of groundwater J_{w}, as shown in table 1:

TABLE 1
values of activity coefficient of groundwater J_{w}

| level | description of groundwater state | J_{w} |
|---|---|---|
| A | tunnel is dry or has a small amount of flowing water (damp or having a small | 1.00 |
| | amount of dripping water) | |
| B | moderate flow, local flushing of joint filling material (linear dripping) | 0.66 |
| C | jet or high-pressure water flow in unfilled fractures of rock mass | 0.50 |
| D | a large amount of high-pressure flowing water gushing out from cracks in the | 0.33 |
| | rock mass | |
| E | abnormally high-water inflow, water pressure decay over time, causing sealing | 0.2-0.1 |
| | material to flow out and potentially collapse | |
| F | abnormally high-water inflow, water pressure maintained at a certain value | 0.1-0.05 |
| | without significant attenuation, causing the sealing material to flow out and | |
| | potentially collapse | |

step S3: characterizing by using an disintegration resistance coefficient I_{d}, an expansion rate V_{d}, and a softening coefficient Ks, respectively, calculating a hydraulic effect coefficient Jₐ based on three indicators of disintegration, expansibility, and softening,

$${J}_{a} = \frac{{V}_{d}}{{I}_{d} \times {K}_{s}}$$

in the above equation, the hydraulic effect coefficient Jₐ is generally greater than 1, and a larger hydraulic coefficient, a more obvious rock mass deterioration when exposed to water;
step S4: determining a tunnel shape coefficient Dᵢ based on a cross-sectional shape of the tunnel:

$${D}_{i} = λ {R}_{q}$$

in the above equation, λ is a tunnel section shape coefficient; due to the large number of horseshoe shaped cross-sections, when the tunnel section is horseshoe shaped, λ=1.0, when the tunnel section is circular, λ=0.8, and R_{q} is an equivalent radius of the tunnel.

When the cross-sectional form is horseshoe shape, the calculation equation is as follows:

$${R}_{q} = \sqrt{\frac{A}{π}}$$

in the equation, A represents an area of the tunnel cross-section.

Step S5: obtaining a long-term strength reduction coefficient J_{c} through laboratory experiments or numerical simulation analysis based on an attenuation law of surrounding rock strength under long-term load, specifically:

$${J}_{c} = \{ \begin{matrix}\frac{{σ}_{c}}{{R}_{b}} & sample is a complete rock block \\ \frac{{σ}_{c}}{{R}_{cm}} & sample is a larger rock mass\end{matrix}$$

in the above equation, σ_{c} refers to a maximum strength value at which the rock can maintain stability without failure under continuous loading.

Step S6: considering basic mechanical properties, occurrence environment characteristics, and time effects of soft rock in tunnels, calculating a harmful deformation index of a soft rock tunnel Hs;

$${H}_{s} = \frac{{J}_{σ}}{{D}_{i}} \times \frac{{J}_{c}}{1 + {J}_{a} - {J}_{a} {J}_{w}}$$

in the equation, J_{σ} is a comprehensive strength stress ratio, J_{w} is a groundwater activity coefficient, Jₐ is the hydraulic effect coefficient, Dᵢ is the tunnel shape coefficient, and J_{c} is the long-term strength reduction coefficient.

Step S7: determining a deformation category of a surrounding rock by comparing obtained harmful deformation index with a harmful deformation classification table of the soft rock tunnel, where the harmful deformation classification of the soft rock tunnel is as shown in table 2;

TABLE 2
harmful deformation classification of the soft rock tunnel

| classification | main description |
|---|---|
| safe deformation | the rock mass has good strength and integrity, and the surrounding |
| | rock can maintain stability on its own |
| first level harmful | the surrounding rock undergoes significant deformation, with a |
| deformation | relatively small deformation rate that remains stable for a period of |
| | time |
| second level harmful | the surrounding rock undergoes significant deformation, with a high |
| deformation | deformation rate, if the support is not strengthened in time, it will |
| | quickly fail |
| third level harmful | the surrounding rock undergoes significant deformation, with a fast |
| deformation | deformation rate and a large amount of flowing water and soil |
| | gushing out |

In some embodiments of the present disclosure, in step S3, the three indicators of disintegration, expansibility, and softening are obtained through the following method:
conducting a disintegration resistance test on a rock sample to obtain the disintegration resistance index I_{d}; obtaining the expansion rate V_{d} based on cementation characteristics and weathering degree of the rock; the soft rock sample being subjected to free immersion for 48 hours to become a saturated sample; conducting uniaxial compressive tests on both saturated and natural samples, where a ratio of their compressive strengths is the softening coefficient Kₛ.

In some embodiments of the present disclosure, in step S4, when the tunnel section is horseshoe shape, λ=1.0, and when the tunnel section is circular, λ=0.8; R_{q} is the equivalent radius of the tunnel; when a cross-sectional shape of the tunnel is horseshoe, its calculation equation is as follows:

$${R}_{q} = \sqrt{\frac{A}{π}}$$

in the above equation: A is an area of the tunnel cross-section.

In some embodiments of the present disclosure, in step S5, a specific process is as follows:
S5.1: conducting triaxial mechanical experiments on rock masses considering seepage conditions to obtain mechanical parameters for rock mass seepage hydromechanical coupling tests;
S5.2: conducting triaxial creep tests under different pore pressures conditions based on obtained mechanical parameters, and obtaining triaxial creep test curves under different pore pressures conditions;
S5.3: drawing a series of Isochronous stress-strain curves by analyzing rheological test data at different stress levels; when there is a clear inflection point in the curve, performing linear fitting on curve segments on two sides of the inflection point; a stress value corresponding to an intersection of two fitted lines is a long-term strength of the rock, σ_{c};
S5.4: calculating the long-term strength reduction coefficient of the rock mass J_{c}:

$${J}_{c} = \{ \begin{matrix}\frac{{σ}_{c}}{{R}_{b}} & sample is a complete rock block \\ \frac{{σ}_{c}}{{R}_{cm}} & sample is a larger rock mass\end{matrix} .$$

In some embodiments of the present disclosure, in step S7, harmful deformation is classified according to the following criteria, specifically:
when the harmful deformation index is between 0 and 0.5, it belongs to an extremely severe compression deformation range and is judged as a third level harmful deformation;
when the harmful deformation index is between 0.5 and 1.5, it belongs to a severe compression deformation range and is judged as a second level harmful deformation;
when the harmful deformation index is between 1.5 and 3.5, it belongs to a medium compression deformation range and is judged as a first level harmful deformation;
when the harmful deformation index is greater than 3.5, it belongs to a non-extrusion deformation range and is judged as a safe deformation.

The present invention further provides a computer-readable storage medium, which stores a computer program. When the computer program is executed by a processor, the method for discriminating soft rock deformation based on the harmful deformation index described in any one of the above is implemented.

Compared with the existing technology, the present invention has the following beneficial effects as follows.

The present disclosure comprehensively considers the physical and mechanical properties, geological conditions, hydrological environment, and time effects of the surrounding rock of soft rock tunnels, overcoming the shortcomings of traditional methods that ignore dynamic factors and environmental influences, thereby making deformation identification more comprehensive and accurate, effectively improving risk prediction capabilities, providing new ideas and methods for deformation identification and classification in soft rock tunnel engineering, and valuable references for similar engineering applications.

### BRIEF DESCRIPTION OF DRAWINGS

FIG. 1 is a flowchart of a discrimination method for soft rock deformation based on harmful deformation index according to the present disclosure.

FIG. 2 shows a relationship between a disintegration resistance index and the number of cycles of red bed soft rock in central Yunnan in an embodiment.

FIGS. 3A, 3B and 3C are triaxial creep test curves under different pore pressures conditions.

FIGS. 4A, 4B and 4C are Isochronous stress-strain curves.

FIGS. 5A, 5B, 5C and 5D are statistical charts of harmful deformation caused by water diversion in central Yunnan.

FIG. 6 is an extrusion deformation prediction curve based on harmful deformation indexes.

### DESCRIPTION OF EMBODIMENTS

In order to clarify the purpose, technical solution, and advantages of the embodiments of the present disclosure, the technical solution of the present disclosure will be described clearly and completely in combination with the accompanying drawings. Obviously, the described embodiments are a part of the embodiments of the present disclosure, not all of them. Based on the embodiments of the present disclosure, all other embodiments obtained by those skilled in the art without creative labor are within the protection scope of the present disclosure.

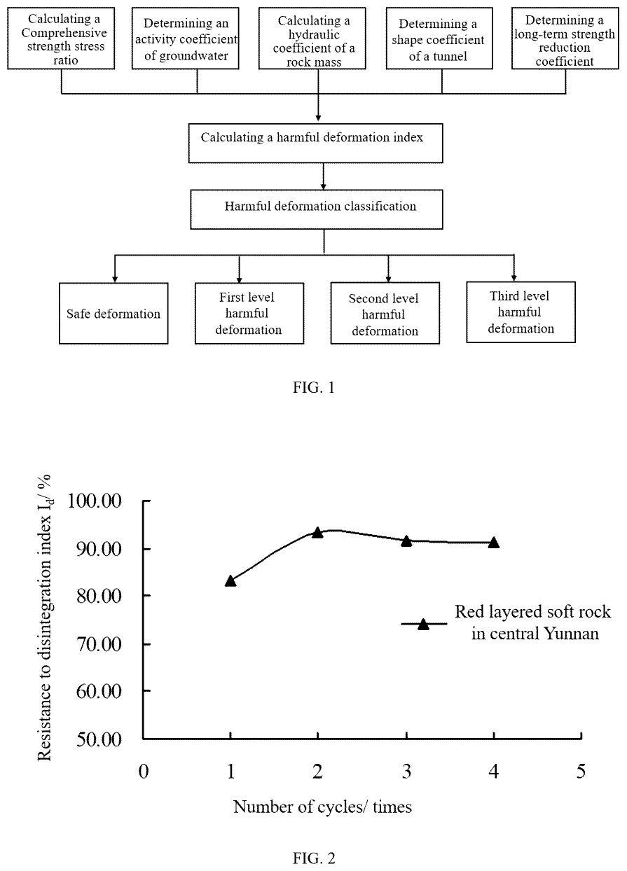

As shown in FIG. 1, a discrimination method for soft rock deformation based on harmful deformation index includes the following steps:
Step S1: measuring a uniaxial compressive strength of a rock R_{b}, a uniaxial compressive strength of a rock mass R_{cm}, and values of high principal stress and low principal stress in a geostatic stress through experiments.

In this embodiment, based on the construction practice of the Chuxiong section of the Yunnan Central Water Diversion Project, 50 cases of large deformation of soft rock in the tunnel of the Chuxiong section of the Yunnan Central Water Diversion Project were collected. As shown in Table 3, the geostatic stress, rock/mass strength, etc. of 10 cases are provided.

TABLE 3
Statistical Table of Squeezing Deformation Characteristics in Soft
Rock Layer Area of Tunnel in Central Yunnan Water Diversion Project

| | | | Small | | | |
|---|---|---|---|---|---|---|
| | | Main | principal | | Groundwater | Groundwater |
| | | stress | stress | Rock/Mass | activity | activity |
| Serials | Engineering and Parts | MPa | MPa | Strength | state | coefficient |
| 1 | Kaija Village Tunnel for | 5.62 | 2.25 | 15/3 | linear | 0.33 |
| | Water Diversion in Central | | | | flowing | |
| | Yunnan | | | | water | |
| | CJCT8 + 585 to CJCT8 + 510 | | | | | |
| 2 | Upstream main tunnel of | 16.41 | 6.56 | 20/7 | linear | 0.66 |
| | Caijia Village Tunnel 4 # | | | | flowing | |
| | Branch for water diversion | | | | water - rainy | |
| | in central Yunnan, with pile | | | | outflow | |
| | number | | | | | |
| | CJCT12 + 595 to | | | | | |
| | CJCT12 + 540 | | | | | |
| 3 | Main tunnel downstream of | 12.29 | 4.92 | 25/10 | dripping | 0.66 |
| | the Caijia Village Tunnel 4 # | | | | water to | |
| | branch of the Central Yunnan | | | | seeping | |
| | Water Diversion Project, | | | | water | |
| | with pile number | | | | | |
| | CJCT12 + 945 to | | | | | |
| | CJCT13 + 049.9 | | | | | |
| 4 | main tunnel downstream of | 7.33 | 2.93 | 40/24 | dripping | 1 |
| | the Caijia Village Tunnel 5 # | | | | water to | |
| | branch of the Central Yunnan | | | | seeping | |
| | Water Diversion Project, | | | | water | |
| | with pile number | | | | | |
| | CJCT16 + 790 to | | | | | |
| | CJCT16 + 837.9 | | | | | |
| 5 | main tunnel upstream of the | 16 | 6.4 | 35/15 | dripping | 1 |
| | Caijia Village Tunnel # 6 | | | | water to | |
| | branch of the Central Yunnan | | | | seeping | |
| | Water Diversion Project, | | | | water | |
| | with pile number | | | | | |
| | CJCT19 + 940 to | | | | | |
| | CJCT19 + 826.4 | | | | | |
| 6 | main tunnel downstream of | 6.33 | 2.53 | 22/12 | damp to | 0.66 |
| | the No. 1 branch of the Liujia | | | | dripping | |
| | Village Tunnel of the Central | | | | water, locally | |
| | Yunnan Water Diversion | | | | linear or | |
| | Project, with pile number | | | | stream like | |
| | CX21 + 424.7 to CX21 + 454.2 | | | | water flow | |
| 7 | Central Yunnan Longtan | 46 | 2.4 | 15/10 | damp cave | 1 |
| | Tunnel 3 # Branch Upstream | | | | walls to | |
| | Main Tunnel, with pile | | | | water | |
| | number | | | | seepage | |
| | rCX127 + 250 to | | | | | |
| | CX127 + 28510 | | | | | |
| 8 | Upstream main tunnel of | 4.3 | 1.72 | 40/15 | damp cave | 1 |
| | Caijia Village Tunnel 2 # | | | | wall | |
| | Branch for water diversion | | | | | |
| | in central Yunnan, with pile | | | | | |
| | number | | | | | |
| | KM4 + 447 to KM4 + 455 | | | | | |
| 9 | Wanjia Tunnel for Water | 12.78 | 5.11 | 15/10 | damp to | 1 |
| | Diversion in Central Yunnan | | | | dripping | |
| | (CX3 + 615) | | | | water | |
| 10 | Wanjia Tunnel for Water | 4.63 | 1.85 | 22/15 | Dry to Wet | 1 |
| | Diversion in Central Yunnan | | | | | |
| | (CX8 + 180) | | | | | |

Based on the data in the example, calculating the comprehensive strength stress ratio, J_{σ}:

$${J}_{σ} = \frac{{R}_{b} \times {R}_{cm}}{3 {k}^{2} \times {σ}_{0}^{2}}$$

Step S2: obtaining an activity coefficient of groundwater A for each group based on the description of the groundwater state for each instance.

Step S3: Firstly, conducting a disintegration resistance test on the rock samples to obtain a relationship between the disintegration resistance index and the number of cycles of the Central Yunnan red layer soft rock, as shown in FIG. 2, and obtaining a disintegration of soft rock I_{d} for each group; secondly, most of the long and large water diversion tunnels of the Central Yunnan Water Diversion Project pass through weakly weathered to fresh rock masses, and the influence of rock swelling is weak. The expansion rate V_{d} of each group is obtained; again, the soft rock sample was subjected to free immersion for 48 hours to become a saturated sample. Uniaxial compressive tests were conducted on both the saturated sample and the natural sample, and a ratio of their compressive strengths was a softening coefficient Ks. The test results are shown in Table 4.

TABLE 4
Statistics of Average Softening Test
Values of Red Layered Soft Rock

| | Compressive strength (MPa) | | Softening |
|---|---|---|---|
| | Natural | Saturated | coefficient |
| Lithology | samples | sample | Kₛ |
| Mudstone | 29.60 | 11.00 | 0.37 |
| Calcareous mudstone | 35.55 | 22.25 | 0.61 |
| Mudstone and | 45.92 | 18.64 | 0.45 |
| limestone | | | |
| Silty mudstone | 39.15 | 21.39 | 0.50 |
| Silty mudstone | 53.85 | 17.86 | 0.34 |
| Siltstone | 107.88 | 70.20 | 0.63 |

Finally, calculating the hydraulic effect coefficient Jₐ for each group of rock masses:

$${J}_{a} = \frac{{V}_{d}}{{I}_{d} \times {K}_{s}} .$$

Step S4: Firstly, calculating an equivalent radius R_{q} of each group of tunnels based on the cross-sectional area of the tunnel; secondly, the shape coefficient of each tunnel section is determined based on its cross-sectional shape. When the section is horseshoe shape, λ=1.0, and when it is circular, λ=0.8. Finally, calculating a shape coefficient Dᵢ for each group of tunnels:

$${D}_{i} = λ {R}_{q} .$$

Step S5: Firstly, conducting triaxial mechanical experiments on red soft rock under different confining pressures (5.0 MPa, 7.0 MPa, and 10.0 MPa) and different seepage pressures (1.0 MPa, 2.0 MPa, and 3.0 MPa). The test is shown in Table 5.

TABLE 5
triaxial mechanical experiments for red
soft rock under seepage conditions

| | Confining | Pore | Sample | Sample | Loading |
|---|---|---|---|---|---|
| Sample | pressure | pressures | diameter | height | rate |
| number | σ_{c} (MPa) | σₚ (MPa) | D (mm) | L (mm) | (mm/min) |
| DTY-S-01 | 5.0 | 1.0 | 50.18 | 100.42 | 0.02 |
| DTY-S-02 | 7.0 | 1.0 | 50.16 | 100.09 | |
| DTY-S-03 | 10.0 | 1.0 | 50.40 | 100.37 | |
| DTY-S-04 | 10.0 | 2.0 | 50.40 | 100.12 | |
| DTY-S-05 | 10.0 | 3.0 | 50.45 | 99.97 | |

Secondly, hydromechanical coupling tests were conducted on red layer soft rock under confining pressures of 5.0, 7.0, and 10.0 MPa, as well as seepage pressures of 1.0, 2.0, and 3.0 MPa. The classical Mohr-Coulomb criterion was used for fitting, and the mechanical parameters of the seepage hydromechanical coupling tests for red layer soft rock were calculated. The results are shown in Table 6.

TABLE 6
Mechanical parameters of red layer soft rock

| | Confining | Pore | | Modulus of | Peak | Yield | | Angle of |
|---|---|---|---|---|---|---|---|---|
| Sample | pressure | pressures | Poisson's | elasticity | intensity | strength | Cohesion | friction |
| Number | (MPa) | (MPa) | ratio | (GPa) | (MPa) | (MPa) | (MPa) | (°) |
| DTY-S-01 | 5.0 | 1.0 | 0.26 | 7.24 | 29.03 | 22.53 | 6.99 | 43.94 |
| DTY-S-02 | 7.0 | 1.0 | 0.22 | 8.97 | 44.18 | 43.30 | | |
| DTY-S-03 | 10.0 | 1.0 | 0.19 | 12.35 | 53.04 | 51.46 | | |
| DTY-S-04 | 10.0 | 2.0 | 0.21 | 12.05 | 48.02 | 28.15 | | |
| DTY-S-05 | 10.0 | 3.0 | 0.24 | 11.89 | 47.13 | 42.42 | | |

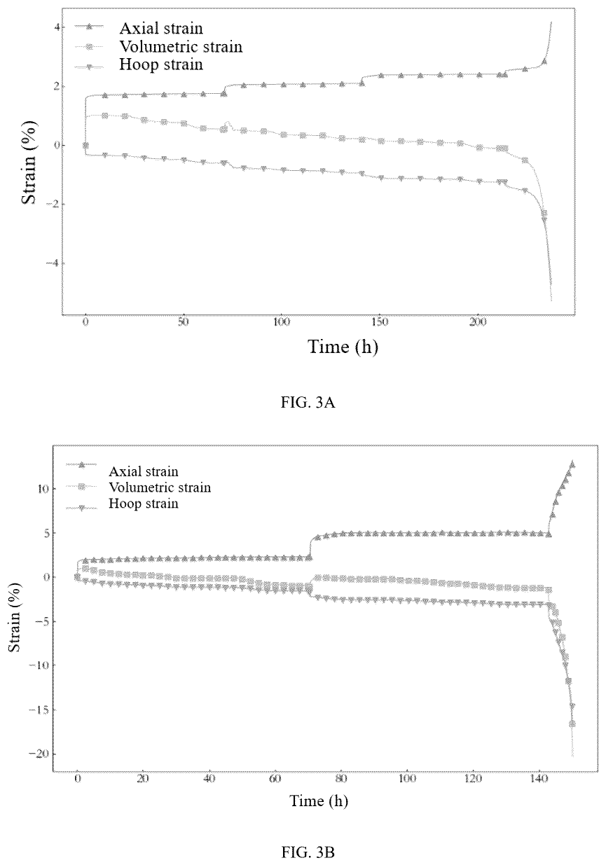

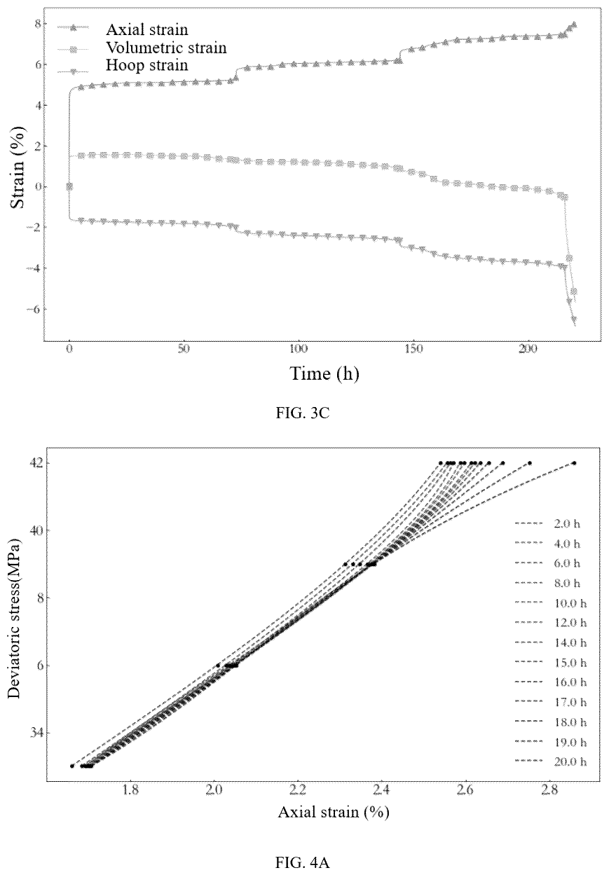

Again, based on the results of triaxial mechanical experiments on red layer soft rock, triaxial creep tests were conducted under different seepage pressure conditions, and triaxial creep test curves were obtained under different seepage pressure conditions. The results are shown in FIG. 3A, it is a rheological test curve of confining pressure of 10.0 MPa and seepage pressure of 1.0 Mpa, FIG. 3B is a rheological test curve of confining pressure of 10.0 MPa and seepage pressure of 2.0 Mpa, and FIG. 3C is a rheological test curve of confining pressure of 10.0 MPa and seepage pressure of 3.0 Mpa.

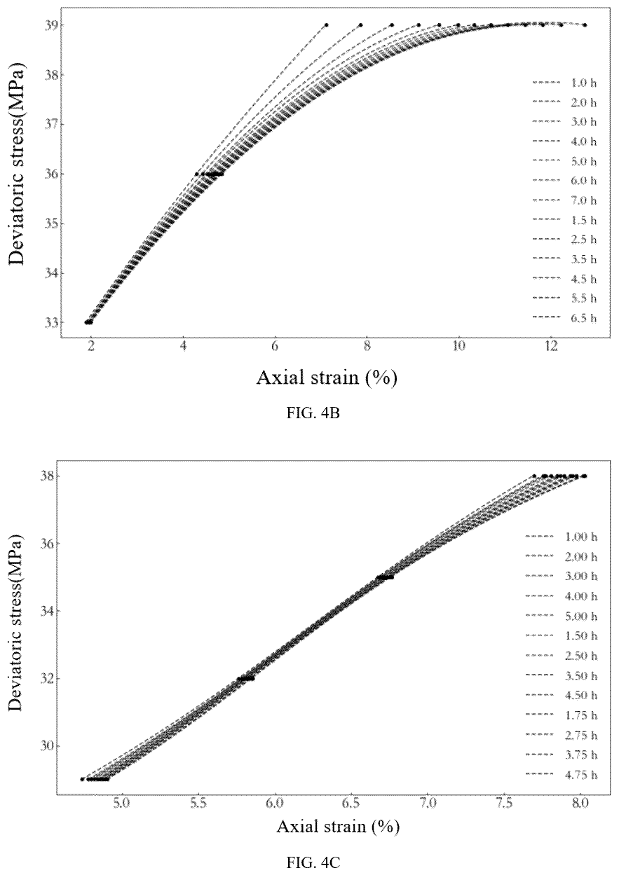

Again, by analyzing the rheological test data under different stress levels, a series of Isochronous stress-strain curves were plotted, as shown in FIG. 4A, and FIG. 4A is a curve of confining pressure of 10.0 MPa and seepage pressure of 1.0 Mpa, FIG. 4B is a curve of confining pressure of 10.0 MPa and seepage pressure of 2.0 Mpa, and FIG. 4C is a curve of confining pressure of 10.0 MPa and seepage pressure of 3.0 Mpa. When there is a clear inflection point in the curve, linear fitting is performed on the curve segments on two sides of the inflection point. A stress value corresponding to an intersection of two fitted lines is the long-term strength of the rock, as shown in Table 7.

TABLE 7
Triaxial creep parameters of red soft
rock under pore pressures conditions

| | Pore | Instantaneous | Long term | |
|---|---|---|---|---|
| Sample | pressures | strength | strength | |
| number | (MPa) | σₛ (MPa) | σ_{∞} (MPa) | σ_{∞}/σₛ |
| DTY-LS-01 | 1.0 | 53.04 | 40.33 | 76% |
| DTY-LS-02 | 2.0 | 48.02 | 37.52 | 78% |
| DTY-LS-03 | 3.0 | 47.13 | 36.29 | 77% |

Finally, when the test specimen is a complete rock block, the long-term strength reduction coefficient J_{c} is:

$${J}_{c} = \{ \begin{matrix}\frac{{σ}_{c}}{{R}_{b}} & sample is a complete rock block \\ \frac{{σ}_{c}}{{R}_{cm}} & sample is a larger rock mass\end{matrix} .$$

Step S6: calculating the harmful deformation index for each group, using the equation:

$${H}_{s} = \frac{{J}_{σ}}{{D}_{i}} \times \frac{{J}_{c}}{1 + {J}_{a} - {J}_{a} {J}_{w}} .$$

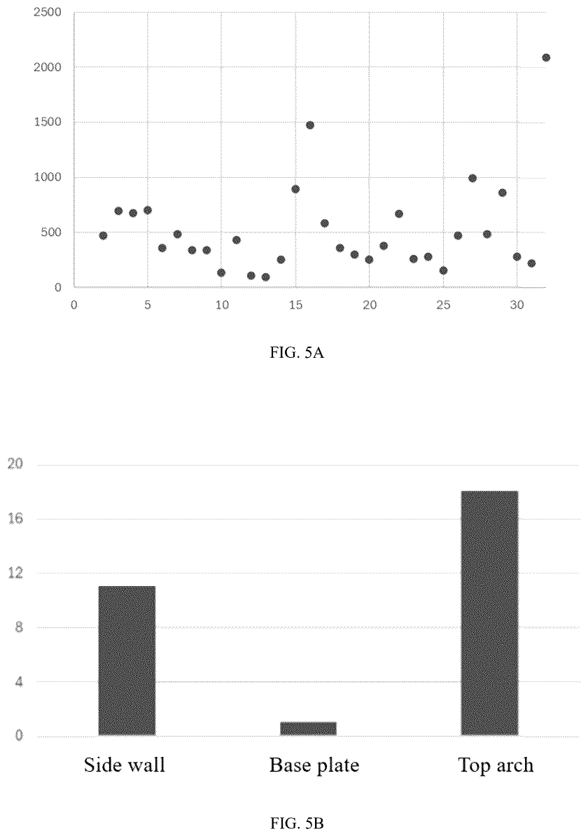

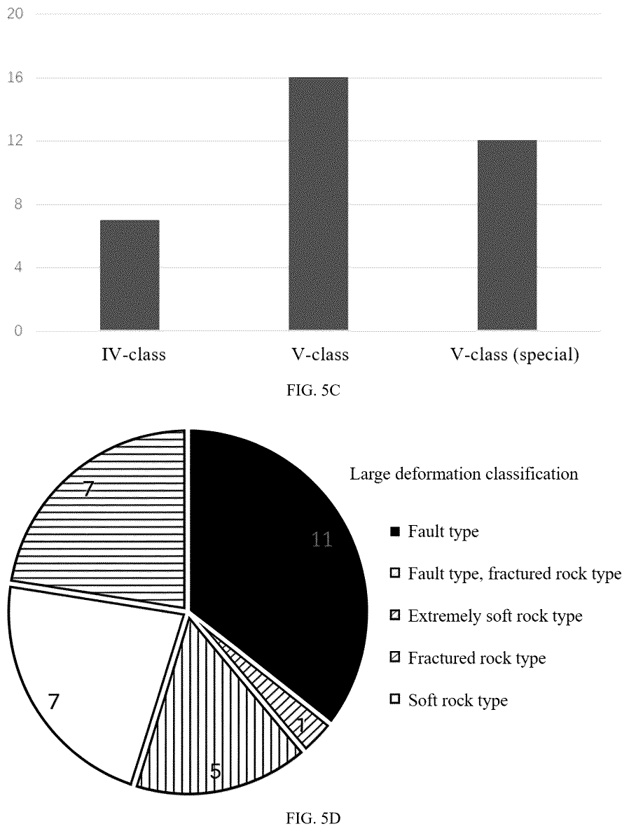

Step S7: Firstly, the harmful deformation index of 50 instance data is statistically analyzed to obtain the large deformation index and deformation law. The results are shown in FIGS. 5A, 5B, 5C and 5D, where FIG. 5A represents the magnitude of harmful deformation, the horizontal axis is the example number, and the vertical axis is the corresponding deformation (unit is mm), FIG. 5B is a location of harmful deformation, FIG. 5C is a surrounding rock category, and FIG. 5D is a geological body type.

Dividing the deformation area into four intervals according to the harmful deformation index: the range of harmful deformation index from 0 to 0.5 is an extremely severe compression deformation interval (third level harmful deformation); the range of harmful deformation index from 0.5 to 1.5 is a severe compression deformation range (second level harmful deformation); the range of harmful deformation index between 1.5 and 3.5 is the moderate compression deformation range (first level harmful deformation); the range with a harmful deformation index greater than 3.5 is the non-extrusion deformation range (safe deformation).

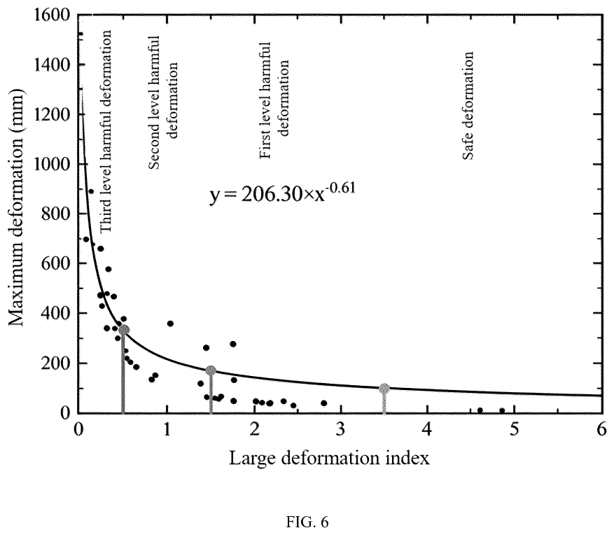

Secondly, the example data was fitted using an exponential function to obtain a prediction curve for extrusion deformation based on the harmful deformation index, as shown in FIG. 6. Finally, the fitting degree R²=0.86. The instance data was predicted using the fitting curve equation, specifically by fitting the predicted curve based on the data obtained from these 50 sets of instances. Comparing and verifying with the statistical data of 50 sets of tunnel soft rock deformation in this example. Applied to 50 sets of tunnel soft rock deformation statistical examples in this case, the predicted correct number of groups is 43, with an accuracy rate of 86%. However, when using the classification standard of strength stress ratio alone, the predicted correct number of groups is 31, with an accuracy rate of only 62%. Therefore, compared to a single strength to stress ratio index, the proposed prediction method based on the large deformation index improves accuracy by more than 30%.

The present invention further provides a computer-readable storage medium, which stores a computer program that, when executed by a processor, can implement the steps of the various method embodiments described above. That is, the present invention can implement all or part of the processes in the above embodiments by instructing relevant hardware through a computer program, which can be stored in a computer-readable storage medium. The computer program, when executed by the processor, can implement the steps of the various method embodiments described above. The computer programs include computer program code, which can be in the form of source code, object code, executable files, or some intermediate forms. Computer readable storage media include: any entity or device capable of carrying computer program code to a device/terminal device, recording media, computer memory, read-only memory (ROM, Read Only Memory), random access memory (RAM, Random Access Memory), electrical carrier signals, telecommunications signals, and software distribution media. For example, it can be a USB flash drive, a portable hard drive, a magnetic disk, or a CD.

Taking the ideal embodiment of the present disclosure as inspiration, relevant personnel can make various changes and modifications within the scope of the technical idea of the present disclosure without departing from the above description. The technical scope of the present disclosure is not limited to the specification, and must be determined based on the scope of the claims.

What is claimed is:

1. A discrimination method for soft rock deformation based on harmful deformation index, including the following steps:
step S1: calculating a comprehensive strength stress ratio J_{σ} based on comprehensive lithology, geostatic stress field, and rock mass structural characteristics, 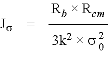
in the above equation, R_{b} is a uniaxial compressive strength of a rock, R_{cm} is a uniaxial compressive strength of a rock mass, σ₀ is a value of a large principal stress of a geostatic stress and k is a ratio of the large principal stress to a small principal stress of the geostatic stress;
step S2: determining an activity coefficient of groundwater J_{w}, as shown in table 1:
TABLE 1
values of activity coefficient of groundwater J_{w}

| level | description of groundwater state | J_{w} |
|---|---|---|
| A | tunnel is dry or has a small amount of flowing water (damp or having a small | 1.00 |
| | amount of dripping water) | |
| B | moderate flow, local flushing of joint filling material (linear dripping) | 0.66 |
| C | jet or high-pressure water flow in unfilled fractures of rock mass | 0.50 |
| D | a large amount of high-pressure flowing water gushing out from cracks in the | 0.33 |
| | rock mass | |
| E | abnormally high-water inflow, water pressure decay over time, causing sealing | 0.2-0.1 |
| | material to flow out and potentially collapse | |
| F | abnormally high-water inflow, water pressure maintained at a certain value | 0.1-0.05 |
| | without significant attenuation, causing the sealing material to flow out and | |
| | potentially collapse | |

step S3: calculating a hydraulic effect coefficient Jₐ based on three indicators of disintegration, expansibility, and softening,
$${J}_{a} = \frac{{V}_{d}}{{I}_{d} \times {K}_{s}}$$
in the above equation, the hydraulic effect coefficient Jₐ is generally greater than 1, and a larger hydraulic coefficient, a more obvious rock mass deterioration when exposed to water; I_{d} is a disintegration of soft rock is measured by its resistance to disintegration index, V_{d} is an expansion rate configured to measure its expansibility, and Kₛ is a softening coefficient configured to measure its softening;
step S4: determining a tunnel shape coefficient Dᵢ based on a cross-sectional shape of the tunnel, with an equation of:
$${D}_{i} = λ {R}_{q}$$
in the above equation, λ is a tunnel section shape coefficient; R_{q} is an equivalent radius of a tunnel;
step S5: obtaining a long-term strength reduction coefficient J_{c}, specifically:
$${J}_{c} = \{ \begin{matrix}\frac{{σ}_{c}}{{R}_{b}} & sample is a complete rock block \\ \frac{{σ}_{c}}{{R}_{cm}} & sample is a larger rock mass\end{matrix}$$
in the above equation, σ_{c} refers to a maximum strength value at which the rock can maintain stability without failure under continuous loading;
step S6: considering factors derived from steps S1-S5, calculating a harmful deformation index of a soft rock tunnel Hs;
$${H}_{s} = \frac{{J}_{σ}}{{D}_{i}} \times \frac{{J}_{c}}{1 + {J}_{a} - {J}_{a} {J}_{w}}$$
in the equation, J_{σ} is a comprehensive strength stress ratio, J_{w} is a groundwater activity coefficient, Jₐ is the hydraulic effect coefficient, Dᵢ is the tunnel shape coefficient, and J_{c} is the long-term strength reduction coefficient;
step S7: determining a deformation category of a surrounding rock by comparing obtained harmful deformation index with a harmful deformation classification table of the soft rock tunnel, wherein the harmful deformation classification of the soft rock tunnel is as shown in table 2;
TABLE 2
harmful deformation classification of the soft rock tunnel

| classification | main description |
|---|---|
| safe deformation | the rock mass has good strength and integrity, and the surrounding |
| | rock can maintain stability on its own |
| first level harmful | the surrounding rock undergoes significant deformation, with a |
| deformation | relatively small deformation rate that remains stable for a period of |
| | time |
| second level harmful | the surrounding rock undergoes significant deformation, with a high |
| deformation | deformation rate, if the support is not strengthened in time, it will |
| | quickly fail |
| third level harmful | the surrounding rock undergoes significant deformation, with a fast |
| deformation | deformation rate and a large amount of flowing water and soil |
| | gushing out |

2. The discrimination method for soft rock deformation based on harmful deformation index according to claim 1, wherein in step S3, the three indicators of disintegration, expansibility, and softening are obtained through the following method:
conducting a disintegration resistance test on a rock sample to obtain the disintegration resistance index I_{d}; obtaining the expansion rate V_{d} based on cementation characteristics and weathering degree of the rock; the soft rock sample being subjected to free immersion for 48 hours to become a saturated sample; conducting uniaxial compressive tests on both saturated and natural samples, wherein a ratio of their compressive strengths is the softening coefficient Kₛ.

3. The discrimination method for soft rock deformation based on harmful deformation index according to claim 2, wherein in step S4, when the tunnel section is horseshoe shape, λ=1.0, and when the tunnel section is circular, λ=0.8; R_{q} is the equivalent radius of the tunnel; when a cross-sectional shape of the tunnel is horseshoe, its calculation equation is as follows:
$${R}_{q} = \sqrt{\frac{A}{π}}$$
in the above equation: A is an area of the tunnel cross-section.

4. The discrimination method for soft rock deformation based on harmful deformation index according to claim 3, wherein in step S5, a specific process is as follows:
S5.1: conducting triaxial mechanical experiments on rock masses considering seepage conditions to obtain mechanical parameters for rock mass seepage hydromechanical coupling tests;
S5.2: conducting triaxial creep tests under different pore pressures conditions based on obtained mechanical parameters, and obtaining triaxial creep test curves under different pore pressures conditions;
S5.3: drawing a series of isochronous stress-strain curves by analyzing rheological test data at different stress levels; when there is a clear inflection point in the curve, performing linear fitting on curve segments on two sides of the inflection point; a stress value corresponding to an intersection of two fitted lines is a long-term strength of the rock, σ_{c};
S5.4: calculating the long-term strength reduction coefficient of the rock mass Jc:
$${J}_{c} = \{ \begin{matrix}\frac{{σ}_{c}}{{R}_{b}} & sample is a complete rock block \\ \frac{{σ}_{c}}{{R}_{cm}} & sample is a larger rock mass\end{matrix} .$$

5. The discrimination method for soft rock deformation based on harmful deformation index according to claim 4, wherein in step S7, harmful deformation is classified according to the following criteria, specifically:
when the harmful deformation index is between 0 and 0.5, it belongs to an extremely severe compression deformation range and is judged as a third level harmful deformation;
when the harmful deformation index is between 0.5 and 1.5, it belongs to a severe compression deformation range and is judged as a second level harmful deformation;
when the harmful deformation index is between 1.5 and 3.5, it belongs to a medium compression deformation range and is judged as a first level harmful deformation;
when the harmful deformation index is greater than 3.5, it belongs to a non-extrusion deformation range and is judged as a safe deformation.

6. A computer-readable storage medium, wherein the computer-readable storage medium stores a computer program that, when executed by a processor, implements the discrimination method for soft rock deformation based on harmful deformation index according to claim 1.
